(19) United States
(12) Patent Application Publication
(10) Pub. No.: US 2013/0316050 A1
(43) Pub. Date: Nov. 28, 2013

(54) NUTRIENT DELIVERY COMPOSITION

(71) Applicants: Meredith Bliss Lincoln, San Jose, CA (US); Leslie Sagalowicz Barber, Menlo Park, CA (US)

(72) Inventors: Meredith Bliss Lincoln, San Jose, CA (US); Leslie Sagalowicz Barber, Menlo Park, CA (US)

(21) Appl. No.: 13/477,531

(22) Filed: May 22, 2012

(51) Int. Cl. A23G 1/54; A23L 1/302; A23L 1/304; A23G 3/36

(52) U.S. Cl. 426/72; 426/103; 426/96

(57) ABSTRACT

A nutrient delivery composition includes a nougat core having a volume and a nougat surface. A chewable coating surrounds the nougat core. One or more nutrients is located within the nougat core, intermediate between the surface and said chocolate coating, or within the coating. A kit for nutrient delivery includes at least two nutrient delivery compositions that vary in contained nutrients. Instructions for the consumption of the compositions on a regular basis to supply a subject with a palatable nutrition supplement are also provided.

### FIELD OF THE INVENTION

The present invention in general relates to a nutrient delivery composition and in particular to a palatable chewy nutrient delivery composition based on a nougat core.

### BACKGROUND OF THE INVENTION

With the industrialization of food production and consumption of highly processed foods, the conventional Western diet contains a limited number of varieties of fruits and vegetables thereby making it difficult to satisfy the recommended daily consumption recommendations for various vitamins, essential minerals, and nutrients. These problems are all the more acute in certain groups that can suffer long term deficits when proper nutrition is not ingested. Representative of these at risk groups are pregnant women, children, and those individuals suffering from an acute nutritional deficit.

While conventional chewable tablet and gelatin based vitamins are readily accepted and consumed by subjects, these conventional vitamin formulations suffer from several notable limitations. These limitations include unpleasant mouth feel and a limited carrying capacity for essential minerals such as iron, calcium, and combinations thereof. In particular, iron delivery while an essential mineral tends to cause stomach upset and constipation in a number of subjects thereby leading to poor compliance in consuming needed vitamins.

Failure to ingest adequate nutrients is associated with pediatric late development, birth defects, and physical symptoms. Thus, there exists a need for nutrient delivery composition able to deliver a large volume of vitamins in a palatable form that improves user compliance and regularly ingesting the composition. There further exists a need for a nutrient delivery composition that renders comparatively high volume minerals of iron and calcium in a palatable form. There further exists a need for a nutrient delivery composition that limits side effects associated with iron consumption.

### SUMMARY OF THE INVENTION

A nutrient delivery composition includes a nougat core having a volume and a nougat surface. A chewable coating surrounds the nougat core. Two or more nutrients are located within the nougat core, intermediate between the surface and said chocolate coating, or within the coating.

A kit for nutrient delivery includes a first nutrient delivery composition that has a first nougat core having a first nougat core volume and a first nougat core surface. A first nougat core surface has a first coating surrounding the first nougat core. A first plurality of nutrients are located within the first nougat core, or intermediate between the first nougat core surface and the coating or within the coating. A second nutrient delivery composition includes a second nougat core having a second nougat core volume and a second nougat core surface and having a second nougat core surface. A second coating surrounds the nougat core. A second plurality of nutrients are located within the second nougat core, or intermediate between the second nougat core surface and the coating or within said coating wherein the first plurality of nutrients varies from second plurality of nutrients. Instructions for the consumption of the first nutrient delivery composition and the second nutrient delivery composition on a regular basis to supply a subject with a palatable nutrition supplement are also provided.

### BRIEF DESCRIPTION OF THE DRAWINGS

The present invention is further detailed with respect to the following exemplary drawing. This drawing is not intended to limit scope of the appending claims to the dimensions or compositions detailed with respect to this figure but rather this figure is intended to illustrate specific attributes of one embodiment of the present invention.

FIG. 1 is an exploded perspective view of an inventive composition depicting an elastic nougat core stretched between bisected hemispheres of composition coating; and

FIG. 2 is a perspective view of a bar form of an inventive nutrient delivery composition.

### DETAILED DESCRIPTION OF THE PREFERRED EMBODIMENTS

The present invention has utility as a composition for administering vitamins, minerals, nutritional supplements, or a combination thereof to a subject, and in particular to a human subject. The inventive composition is based upon a nougat core that is amenable to containing a formulation containing a variety of vitamins, minerals, and nutritional supplements that are dissolved,suspended, or mixed particulate within the nougat core that is covered with a chewy coating of a material such as chocolate, caramel, or other conventional confectionary. It has been surprisingly found that the unpleasant taste or texture associated with active agents is in part masked by the coating to improve the consumption experience and thereby consumption compliance. Additionally, stomach upset associated with iron supplement is reduced with the inventive composition relative to a conventional iron supplement.

As used herein, the term “nutrient” is used collectively to include organic compound vitamins, dietary minerals, essential fatty acids, and essential amino acids. Nutrient as used herein is also intended to include forms of vitamins, dietary minerals, essential fatty acids, and essential amino acids inclusive of various moieties or pro-forms of the nutrient that are cleaved to the active form of the nutrient by endogenous subject enzymes. Such nutrients are intended to be present in United States Pharmacopeia form (USP) and in quantifiable amounts, as opposed to natural plant extracts that may contain incidental nutrients and if so, in variable concentrations.

As used herein, “nougat” is defined as an aerated confection based on a high boiling syrup such as corn syrup or sugar syrup intermixed with various proteins such as gelatin, albumin, milk proteins, vegetable proteins, or combinations thereof to achieve a density of between 0.25 and 0.9. Marshmallow is explicitly defined as a form of nougat according to the present invention.

As used herein, “iron” is defined to include elemental (zero oxidation state) metal, and biologically metabolized salts and complexes of iron.

As used herein, “calcium” is defined to include biologically metabolized salts, and complexes containing calcium in a 2+ oxidation state.

An inventive composition shown generally at 10 has a nougat core 12. The core 12 defining a volume and bound by a surface 14. The nougat core 12 is encompassed within a coating 16. The coating 16 of a chewable and palatable substance. The coating 16 is readily formed from cocoa products that illustratively include bitter sweet chocolate, milk chocolate, white chocolate (cocoa butter) and dark chocolate. Other substances from which coating 16 is formed include particulate encrusted nougat where the particuate illustratively includes puffed cereal, nut pieces, coconut, and fruit pieces; caramel; nougats; fudges; fondants; and combinations thereof.

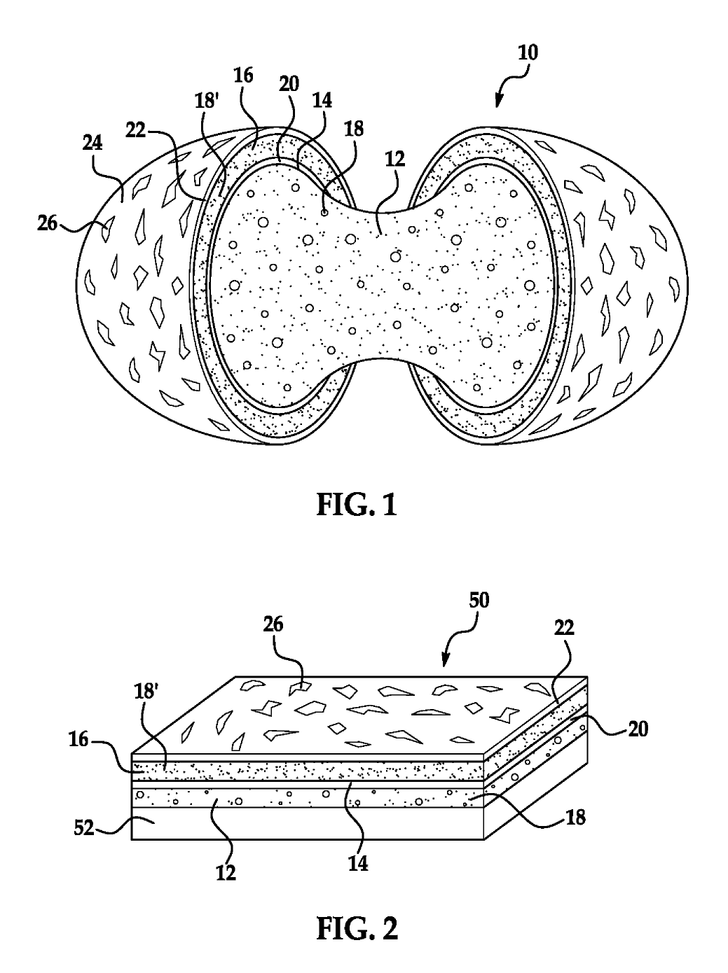

Two or more active ingredients that are nutrients are present within the core 12, the coating 16, or a combination thereof. In certain specific embodiments, nutrients operative herein include vitamin A, vitamin C, vitamin D, vitamin E, thiamin, vitamin B-2, vitamin B-6, niacin, vitamin B-12, folic acid, calcium, iron, zinc, unsaturated fatty acids, essential amino acids, and a combination thereof. It is appreciated that various active ingredient nutrients are readily formulated with nutrient dosings appropriate for specific subject populations based on nutritional needs. By way of example, an inventive nutrient delivery composition is formulated for a specific group based on nutrient needs, a group illustratively including children, adolescents, adult women, pregnant women, post-menopausal women, adult males, and geriatric males within a subject population. In specific embodiments of the composition provided in FIG. 1, the active ingredients of nutrients are denoted collectively at 18 in core 12 and at 18′ within the coating 16.

The inventive composition is fortified with nutrients. In specific embodiments the nutrients are intermixed with the nougat during crystallization and at an elevated temperature above 20° C. or during crystallization and/or cooling to 20° C.

Without intending to be bound to a particular theory, it is believed that the coating 16 smeared or otherwise interacts with subject taste buds to a greater extent than the core 12 so as to provide a subject with a taste sensation with the coating. In inventive embodiments where the coating 16 is devoid of active ingredients 18′, or has active ingredients 18′ present in a limited quantity, the subject as any unpleasant taste associated with the core 12 is masked thereby creating a pleasant experience of consuming the inventive composition and the active ingredients contained therewith.

In certain inventive embodiments, an intermediate layer 20 is provided between the core 12 and the coating 16. The intermediate layer 20 affords processing benefits in certain inventive embodiments such as functioning as an adhesive layer between the core 12 and the coating 16, barrier to limit migration of active ingredients between the core 12 and coating 16 and to preclude blending. In other embodiments, a finish coating 22 is provided external to coating 16. The external layer 22 illustratively provides modification to surface properties of coating 16, illustratively affords luster, a higher softening point, and moisture barrier. Intermediate layer 20 and external layer 22 are each independently produced from materials including conventional confectionary coatings such as waxes, sugar coatings, and gums. Each of the layers 20 or 22, if present, optionally includes sweeteners such as sucrose, corn syrup; sugar alcohols, artificial sweeteners, natural product sweeteners, and dipeptide sweeteners; bulking agents such as polydextrose, cellulosic materials, flavorants, dyes, and emulsifiers. The outer surface 24 of an inventive composition 10 defined by external layer 22 or coating 16 in some specific embodiments is decorated with granules 26. The granules 26 illustratively including nuts, dried fruit, coconut, baked product crumbs, and puffed cereal grains. It is appreciated that in addition to the ball form of an inventive composition 10 as shown in FIG. 1, an inventive composition is readily prepared in a bar form shown generally at 50 in FIG. 2 where like numerals have the meaning ascribed thereto with respect to FIG. 1. A composition 50 is depicted with the relative thickness of the various layers being distorted for visual clarity. A composition 50 includes a substrate 52. The substrate 52 illustratively including baked product such as a cookie or biscuit, granola, chocolate, or a combination thereof [Please confirm]. It is appreciated that in specific embodiments, at least one of the layers 20 or 22 or the coating 16 envelopes the core 12 alone, or the core 12 and the substrate 52. One such embodiment, the coating 16 envelopes the core 12 and the substrate 52.

An inventive composition is fortified with nutrients. The U.S. Recommended Dietary Allowances (U.S. RDA) are a set of nutrient standards established by the Food and Nutrition Board of the National Academy of Sciences (Food and Nutrition Board, 1989, Recommended Dietary Allowances, 10 ed., National Research Council, National Academy of Sciences, Washington, D.C.). The RDA's for nutrients constitute the average daily intake considered adequate to meet the nutritional needs of most healthy individuals in the United States. The RDA for a particular nutrient are appreciated to vary depending on age; gender; and physiological state such as pregnancy. The Reference Daily Intakes (RDI) for vitamins and minerals were established by the Food and Drug Administration to reflect the average nutrient allowances for adults and are used for nutrition labeling on food products in the United States. Specific embodiments of the present invention optionally contain vitamins such as of vitamins A, D, E, K, C (ascorbic acid), thiamin, riboflavin, niacin, vitamin B₆, folate, vitamin B₁₂, biotin, and pantothenic acid. These vitamin sources are preferably present in nutritionally relevant amounts. Preferably, a vitamin or other nutrient is present in an amount of at least about 1% of the U.S. RDA or RDI for a given nutrient, and more preferably from about 1% to about 100% of RDI, and most preferably from about 10% to about 100% of the U.S. RDA or RDI per daily recommended intake of an inventive composition. It is appreciated that the optimal daily intake of a given nutrient varies with the individual user, with greater than U.S. RDA or RDI intakes being beneficial in some circumstances.

In general, the U.S. RDA for vitamin A ranges from about 375 μg RE (retinol equivalent) to about 1300 μg RE, depending on age and physiological state. The U.S. RDA for vitamin D ranges from about 5 μg to about 10 μg (as cholecalciferol). The U.S. RDA for vitamin E ranges from about 3 mg TE (α-tocopherol equivalent) to about 12 mg TE. The U.S. RDA for vitamin K ranges from 5 μg to 80 μg. The U.S. RDA of vitamin C ranges from about 30 mg to about 95 mg. The U.S. RDA for thiamin ranges from about 0.3 mg to about 1.6 mg. The U.S. RDA for riboflavin ranges from about 0.4 mg to about 1.8 mg. The U.S. RDA for niacin ranges from about 5 mg to about 20 mg. The U.S. RDA for vitamin B₆ ranges from about 0.3 mg to about 2.2 mg. The U.S. RDA for folate ranges from about 25 μg to about 400 μg. The U.S. RDA for vitamin B₁₂ ranges from about 0.3 μg to about 2.6 μg. The RDI's established by the Food and Drug Administration for various vitamins are as follows (Code of Federal Reguations, Title 21, Section 101.9: Nutrition Labeling of Food, 21CFR 101.9, revised as of Apr. 1, 1999): Vitamin A=5,000 International Units (1U; equals 875 μg RE); Vitamin D=400 IU (equals 6.5 μg); Vitamin E=30 IU (equals 9 mg α-tocopherol equivalents); Vitamin K=80 μg; Vitamin C=60 mg; thiamin=1.5 mg; riboflavin=1.7 mg; niacin=20 mg; Vitamin B₆ =2.0 mg; folate=400 μg; Vitamin B₁₂=6 μg; biotin=300 μg; pantothenic acid=10 mg.

Vitamin A precursors (provitamin A, carotenoids) are readily used herein and are metabolized to Vitamin A in vivo, these precursors illustratively include β-carotene, α-carotene, β-carotenals, cryptoxanthin and combinations thereof. The vitamin A esters (e.g., retinyl palmitate; retinyl acetate) and βb -carotene are highly preferred forms of vitamin A. Vitamin D sources operative herein illustratively include cholecalciferol (D₃), ergocalciferol (D₂), and their biologically active metabolites and precursors, such as 1-α-hydroxy vitamin D, 25-hydroxy vitamin D, 1,25-dihydroxy vitamin D and combinations thereof. Vitamin D as cholecalciferol is preferred. Sources of vitamin E include d1-alpha tocopherol (all-rac) and its esters, such as d1-α-tocopheryl acetate and succinate, d1-α-tocopherol (RRR) and its esters, d-α-tocopherol and its esters, β-tocopherol, γ-tocopherol, and their esters, tocopheryl nicotinate, and the like. Vitamin K can be selected from phylloquinone (K₁), menaquinone (K₂), menadione and their salts and derivatives. Vitamin K₁is highly preferred. L-ascorbic acid is particularly preferred as a vitamin C source for the present invention. However other forms of vitamin C, for example, D-ascorbic acid, D-dehydroascorbic acid, L-isoascorbic acid, L-dehydroascorbic acid, and esters of ascorbic acid (e.g., ascorbyl palmitate) may also be used. The hydrochloride and nitrate salts of thiamin and thiamin alkyl disulfides such as the prophyidisulfide, tetrahydrofurfuryl disulfide, O-benzoyl disulfide can be used in the present invention. The hydrochloride and nitrate salts of thiamin are highly preferred. The sources of riboflavin are selected, for example, from crystalline riboflavin coenzyme forms of riboflavin such as flavin adenine dinucleotide, flavin adenine mononucleotide, riboflavin 5′-phosphate and their salts. Riboflavin is highly preferred. Sources of niacin include nicotinic acid, nicotinamide, the coenzyme forms of niacin such as nicotinamide adenine dinucleotide, and nicotinamide adenine dinucleotide phosphate. Particularly preferred are nicotinamide and nicotinic acid. Vitamin B₆ can be selected from hydrochloride salts or 5′-phosphates of pyridoxine, pyridoxamine, pyridoxal. The preferred vitamin B₆ is pyridoxine hydrochloride. The folate can be in the form of folic acid, mono and polyglutamyl folates, dihydro and tetrahydro folates, methyl and formyl folates. Folic acid is a highly preferred form of folate. Sources of vitamin B₁₂ are, for example, cyanocobalamin, methylcobalamin, 5′-deoxy-adenosylcobalamin and the like. Cyanocobalamin is highly preferred. Sources of biotin can be selected from D-biotin, oxybiotin, biocytin, biotinol and the like. D-biotin and biocytin are highly preferred. For pantothenic acid, the sources can be in the form of salts such as calcium pantothenate or as panthenol, or in the form of coenzyme A. Calcium pantothenate is a highly preferred source of pantothenic acid.

Embodiments of the present invention may be fortified with minerals such as calcium, phosphorus, magnesium, iron, zinc, iodine, selenium, copper, manganese, fluoride, chromium, molybdenum, sodium, potassium, and chloride. The minerals sources are preferably present in nutritionally relevant amounts, which means that the mineral sources used in the practice of this invention provide a nourishing amount of said minerals. Preferably, this amount comprises at least about 1% of the U.S. RDA or RDI for these minerals, more preferably from about 1% to about 100%, and most preferably from about 10% to about 100% of the U.S. RDA or RDI per 30 g reference serving of the finished product. Of course, it is recognized that the preferred daily intake of any mineral may vary with the user, with greater than the U.S. RDA or RDI intakes being beneficial in some circumstances.

In general, the U.S. RDA for calcium ranges from 400 mg for infants to 1200 mg for adults (Food and Nutrition Board, 1989; Gregory, 1996). The U.S. RDA for phosphorus ranges from 300 mg to 1200 mg. The U.S. RDA for magnesium ranges from 40 mg to 400 mg. The U.S. RDA for iron ranges from 6 mg to 30 mg, depending somewhat on age and physiological state. The U.S. RDA for zinc ranges from 5 mg to 19 mg. The U.S. RDA for iodine ranges for 40 μg to 200 μg. The U.S. RDA for selenium ranges from 10 μg to 75 μg. There are no official U.S. RDA ranges specified for copper, manganese, chromium, molybdenum and fluoride. However, the Food and Nutrition Board has specified an estimated safe and adequate daily dietary intake for copper of about 1.5-3.0 mg, for manganese of about 2.0-5.0 mg, for chromium of about 50-200 μg, and for molybdenum of about 75-250 μg. A safe and adequate range for fluoride is 1.5-4.0 mg (Food and Nutrition Board, 1989). There are no official U.S. RDA ranges specified for sodium, potassium and chloride. However, the Food and Nutrition Board has specified an estimated minimum requirement for chloride of 50-750 mg, depending upon age. The RDI's established by the Food and Drug Administration for various minerals are as follows (Code of Federal Regulations, Title 21, §101.9: Nutrition Labeling of Food, 21 CFR §101.9, revised as of Apr. 1, 1999): calcium=1000 mg; phosphorus=1000 mg; iron=18 mg; zinc=15 mg; iodine=150 μg; magnesium=400 mg; selenium=70 μg; copper=2.0 mg; manganese=2.0 mg; chromium=120 μg; molybdenum=75 μg; and chloride=3,400 mg. The embodiments of the invention include any of these latter minerals should employ levels known to be safe without risk of toxicity.

The source of the mineral salt, both those with established U.S. RDA levels or with safe and adequate intake levels, as well as those with no as yet established human requirement, used in the practice of this invention, can be any of the well known salts including carbonate, oxide, hydroxide, chloride, sulfate, phosphate, pyrophosphate, gluconate, lactate, acetate, fumarate, citrate, malate, amino acids and the like for the cationic minerals and sodium, potassium, calcium, magnesium and the like for the anionic minerals. However, the particular salt used and the level will depend upon their interaction with other food product ingredients. Elemental iron (electrolytic or reduced iron) is another preferred source of iron.

If desired, coloring agents can also be added to the food compositions of the present invention. Any soluble coloring agents approved for food use can be utilized for the present invention.

When desired, preservatives, such as sorbic acid, benzoic acid, hexametaphosphate and salts thereof, can be added into embodiments of the present invention.

Also, if desired, the composition can contain an acidulant including but not limited to malic, citric, tartaric, and fumaric acids and mixtures thereof.

Organic as well as inorganic edible acids are used to adjust the pH of Applicants' foods. The preferred acids are edible organic acids that include citric acid, malic acid, fumaric acid, adipic acid, phosphoric acid, gluconic acid, tartaric acid, ascorbic acid.

Iron is delivered in a variety of conventional forms conventional to the art illustratively including iron sulfate, iron fumarate, iron gluconate, iron dextran, an iron carbonyl complex, an iron complex of ascorbic acid, ferroglycine sulfate, as well as heme iron polypeptide, iron oxide, and combinations thereof. To limit the discomfort some subjects experience through ingestion of iron, in specific embodiments, the iron nutrient is encapsulated. Conventional encapsulates include gelatin, edible waxes, methylacrylate-containing copolymers, cellulose acetate succinate, hydroxypropyl methylcellulose phthalate, hydroxypropyl methylcellulose acetate succinate, polyvinyl acetate phthalate, alginates, stearic acid, and combinations thereof. Specific embodiments containing iron, a stool softener such as fiber, probiotics, docusate, or combinations thereof are also provided to reduce in part the constipative effects associated with iron ingestion.

According to the present invention, a composition is provided in certain embodiments as a multi-vitamin nutritional supplement containing a variety of nutrients, a nougat core, and a chocolate coating that has a caloric content of between ten and fifty kilocalories (equivalent to nutritional calories) and a total volume of from four to twenty cubic centimeters and in specific embodiments from four to eight cubic centimeters.

Recipes, and processes for creating a base nougat into which various nutrients are readily intermixed are well known to the art as illustrated, for example, in U.S. Pat. No. 4,911,937, column 5, line 60-column 19, line 48.

An inventive nutrient composition is readily processed, and packaged like a conventional nutritional supplement. In specific embodiments, two or more inventive nutrient composition pieces are packaged together with the pieces varying in a property between the individual pieces of inventive composition with respect to at least one of nutrient composition, flavorants, shape, and volume. An inventive kit containing variant inventive nutrient compositions provides the attribute of superior palatability as a result of the comparatively large nougat volumes allowing for low concentration of nutrients that provide a poor taste or mouth feel to a subject. Additionally, specific embodiments, the nutrient constituents and/or loadings vary between individual pieces within a kit to achieve improved palatability, lessened negative interaction between nutrients, which is for example, between iron and phosphates; or a combination thereof

The present invention is further detailed with respect to the following nonlimiting examples. These examples are intended to be illustrative of specific embodiments and should not be construed as limiting the pending claims to the scope of these examples.

### EXAMPLES

### Example 1

A nougat is prepared from corn syrup, sugar, egg whites, potato starch, vanilla, butter, coconut oil, and glycerol monostearate. To the resulting mixture nutrients are added and intermixed to form a nutrient enriched nougat. Nutrient enriched nougat is formed into one centimeter diameter spheres and cooled prior to enrobement with dark chocolate composed of sugar, chocolate liqueur, cocoa butter, milk fat, soy lecithin, and vanilla. The resulting chewable chocolate ball constitutes a prenatal multi-vitamin chocolate ball that weights approximately four 4.6 grams and has a nutritional attributes found in Table 1.

TABLE 1
Prenatal Supplement Facts

| Serving Size: 1 Ball | | | |
|---|---|---|---|
| Amount Per 1 Ball | | | % Daily Value** |
| | Calories from | | for Pregnant or |
| Calories 20 | Fat 10 | | Lactating Women |
| Total Fat | 1 | g | 1.5% |
| Saturated Fat | 0.7 | g | 3% |
| Trans Fat | 0. | g | |
| Total Carbohydrates | 2 | g | 1% |
| Sugars | 2 | g | † |
| Vitamin A (as beta-carotene) | 4000 | IU | 50% |
| Vitamin C (from ascorbic acid) | 60 | mg | 100% |
| Vitamin D (as cholecalciferol) | 800 | IU | 200% |
| Vitamin E (from d-alpha-tocopheryl | 18 | IU | 100% |
| succinate) | | | |
| Thiamin (from thiamin mononitrate) | 1.7 | mg | 100% |
| Riboflavin (vitamin B-2) | 2 | mg | 100% |
| Niacin (as niacinamide) | 20 | mg | 100% |
| Vitamin B-6 (as pyridoxine HCI) | 2.6 | mg | 100% |
| Folic Acid | 800 | mcg | 100% |
| Vitamin B-12 (as cyanocobalamin) | 8 | mcg | 100% |
| Calcium (from calcium carbonate) | 50 | mg | 5% |
| Iron (reduced from iron | 18 | mg | 100% |
| pentacarbonyl) | | | |
| Zinc (from zinc oxide) | 4.2 | mg | 28% |

**Percent Daily Values are based on a 2,000 calorie diet.
† Daily Value not established.

### Example 2

The chocolate ball of Example 1 is produced except that the nutrients of example 1 are replaced with 200 international units (IU) of vitamin D3, 800 IU of beta carotene, 200 milligrams (mg) of omega-3 DHA, and 80 mg of powdered calcium carbonate, a natural berry flavor and gum arabic are added to the coating to modify taste and texture, respectively. Resulting 5 gm chocolate ball has nutritional content shown in Table 2.

TABLE 2
DHA Supplement Facts

| Serving Size: 1 Ball | | | |
|---|---|---|---|
| Amount Per 1 Ball | | | % Daily Value** |
| | Calories from | | for Pregnant or |
| Calories 21 | Fat 12 | | Lactating Women |
| Total Fat | 1 | g | 1.5% |
| Saturated Fat | 0.4 | g | 2% |
| Trans Fat | 0 | g | |
| Total Carbohydrates | 3 | g | 1% |
| Sugars | 2 | g | † |
| Vitamin D3 | 200 | IU | 50% |
| Vitamin A (Beta Carotene) | 800 | IU | 10% |
| Omega-3 DHA | 200 | mg | † |
| Calcium | 80 | mg | 6% |

**Percent Daily Values are based on a 2,000 calorie diet.
† Daily Value not established.

### Example 3

Thirty pieces of the chocolate ball formed per example 1 are packaged in a bottle while thirty pieces of the chocolate ball formed per example 2 are packaged in a second bottle, the first bottle and second bottle together in a unified kit with instructions for the ingestion of one each of the chocolate balls of example 1 and example 2 on a daily basis to provide prenatal vitamins to a subject. A group of 10 volunteers were asked to consume one each of the chocolate balls per example 1 and per example 2 on a daily basis for one month and then asked to evaluate the taste and their compliance rate. Evaluations yielded a taste rating of 4.6 on a 5 point scale with 5 being excellent and compliance rate of 91% during the course of the test.

### COMPARATIVE EXAMPLE

Nutrients of table 1 were compacted into a conventional chewable tablet containing vanilla flavorant including corn starch as a filler. Likewise, the composition of table 2 is formed in a tablet. A test group of 10 volunteers consume these comparative tablets on a daily basis simultaneously with consuming 3.5 g of chocolate after a one month trial, the subject rating as to taste of 2.3 on a 5 point scale with 5 being excellent is noted along with a compliance rate of 42%.

### Example 4

A nougat per example 1 is cut and applied to a tea biscuit in an amount of about 0.5 cubic centimeters with the biscuit and nougat both enrobed within dark chocolate and having the nutrient loadings per table 1 with an increase in caloric content, fat, and carbohydrates associated with the biscuit and the additional chocolate needed to enrobe the biscuit and nougat compared to the spherical ball of example 1. Subject acceptance is similar to that noted in example 3.

### Example 5

The chocolate ball of example 1 is reformulated with a nutrient loading particularly well suited as a children's multivitamin supplement having a nutrient content as detailed in Table 3 and a caramel coating in place of chocolate with a change in weight associated with this coating. Due to the chewy nature of the composition administration to children younger than 6 is not recommended without adult supervision owing to choking concerns.

TABLE 3

| Serving Size: 1 Ball | | | |
|---|---|---|---|
| Amount Per 1 Ball | | | % Daily Value** |
| | Calories | | for Children |
| Calories 25 | from Fat 6 | | ages 6 to 12 |
| Total Fat | 1 | g | 1.5% |
| Saturated Fat | 0.6 | g | 2% |
| Trans Fat | 0. | g | |
| Total Carbohydrates | 3 | g | 1% |
| Sugars | 3 | g | † |
| Vitamin A (as beta-carotene) | 2500 | IU | 50% |
| Vitamin C (from ascorbic acid) | 60 | mg | 100% |
| Vitamin D (as cholecalciferol) | 400 | IU | 100% |
| Vitamin E (from d-alpha- | 15 | IU | 100% |
| tocopheryl succinate) | | | |
| Thiamin (from thiamin mononitrate) | 1.7 | mg | 100% |
| Riboflavin (vitamin B-2) | 2 | mg | 100% |
| Niacin (as niacinamide) | 20 | mg | 100% |
| Vitamin B-6 (as pyridoxine HCI) | 2.6 | mg | 100% |
| Folic Acid | 400 | mcg | 100% |
| Vitamin B-12 (as cyanocobalamin) | 8 | mcg | 100% |
| Pantothenic acid (from calcium | 10 | mg | 100% |
| pantothenate) | | | |
| Iodine (from potassium iodide) | 160 | mcg | 100% |
| Zinc (from zinc oxide) | 4.2 | mg | 30% |

**Percent Daily Values are based on a 2,000 calorie diet.
† Daily Value not established.

### Example 5

Chocolate ball per example 1 is formed with confectioners sugar forming an intermediate layer between the nougat and chocolate coating. Subject acceptance is noted to be similar to that detailed in example 3.

### Example 6

The chocolate ball of example 5 is produced and the chocolate coating is overlayered with an external layer of beeswax decorated with flakes of dried sweentened cherries. Subject acceptance is similar to that noted in example 3.

Various modifications of the present invention, in addition to those shown and described herein, will be apparent to those skilled in the art of the above description. Such modifications are also intended to fall within the scope of the appended claims.

Any patents or publications mentioned in this specification are indicative of the levels of those skilled in the art to which the invention pertains. These patents and publications are herein incorporated by reference to the same extent as if each individual publication was specifically and individually indicated to be incorporated by reference.

The foregoing description is illustrative of particular embodiments of the invention, but is not meant to be a limitation upon the practice thereof The following claims, including all equivalents thereof, are intended to define the scope of the invention.

1. A nutrient delivery composition comprising:
a nougat core having a volume and a nougat surface;
a chewable coating surrounding said nougat core; and
two or more nutrients located within said nougat core, intermediate between the surface and said chewable coating, or within said coating.

2. The composition of claim 1 wherein said coating comprises chocolate.

3. The composition of claim 1 wherein said coating is at least one of: particulate encrusted nougat, caramel, nougat, fudges, or fondants.

4. The composition of claim 1 wherein said core comprises marshmallow.

5. The composition of claim 1 further comprising an intermediate layer, intermediate between said nougat core and said coating.

6. The composition of claim 1 further comprising granules decorating an outer surface of said coating.

7. The composition of claim 1 wherein said one or more nutrients comprise a plurality of vitamins, and iron.

8. The composition of claim 7 further comprising a fatty acid.

9. The composition of claim 7 further comprising calcium.

10. The composition of claim 8 wherein said iron is encapsulated.

11. The composition of claim 1 wherein said core forms a sheet and said coating is overlayered onto said sheet.

12. The composition of claim 11 further comprising an edible substrate.

13. The composition of claim 12 wherein said coating is chocolate and enrobes said nougat core and said substrate.

14. The composition of claim 1 wherein said two or more nutrients are located within said nougat core.

15. A kit for nutrient delivery comprising:
a first nutrient delivery system comprising: a first nougat core having a first nougat core volume and a first nougat core surface; a first nougat core surface; a first coating surrounding first nougat core; and a first plurality of nutrients located within said first nougat core, or intermediate between the first nougat core surface and said coating or within said coating;
a second nutrient delivery system comprising: a second nougat core having a second nougat core volume and a second nougat core surface; and a second nougat core surface; a second coating surrounding second nougat core; and a second plurality of nutrients located within said second nougat core, or intermediate between the second nougat core surface and said coating or within said coating wherein said first plurality of nutrients varies from second plurality of nutrients; and
instructions for the consumption of said first nutrient delivery composition and said second nutrient delivery composition on a regular basis to supply subject with a palatable nutrition supplement.

16. The kit of claim 15 wherein said first nutrient delivery composition comprises iron and said second nutrient delivery composition comprises calcium.

17. The kit of claim 16 wherein said first nutrient delivery composition comprises encapsulated iron and excludes calcium.

18. The kit of claim 15 wherein said first nutrient delivery composition comprises 3-docosahexaenoic acid.
